(19) United States
(12) Patent Application Publication
(10) Pub. No.: US 2005/0120616 A1
(43) Pub. Date: Jun. 9, 2005

(54) Bird abatement system for boats

(76) Inventor: Joe Stugan, San Francisco, CA (US)

Correspondence Address: LITMAN LAW OFFICES, LTD, PO BOX 15035, CRYSTAL CITY STATION, ARLINGTON, VA, 22215, US

(21) Appl. No.: 10/727,598

(22) Filed: Dec. 5, 2003

(51) Int. Cl. A01M 19/00; A01M 23/38

(52) U.S. Cl. 43/98

(57) ABSTRACT

A bird abatement system for boats includes a generally circular element with a top side and a bottom side, a power supply, a positively charged wire having a predetermined length, and a negatively charged wire having a predetermined length. The positively charged and negatively charged wires are embedded/attached in the top side so that they are proximate one another for the extent of their length, inhibit birds from resting, eating, and depositing their waste on boats, and enhance the cleanliness of canvas and gel-coat of any boat.

### BACKGROUND OF THE INVENTION

1. Field of the Invention

The present invention generally relates to boats and, more particularly, to a bird abatement system for boats.

2. Description of the Related Art

Many boat owners take pride in the characteristics of their boats. Boat appearance is one important characteristic on which boat owners spend a great deal of time and energy. Boats are typically open to the elements and are subject to damage from airborne hazards, such as bird droppings. One popular boat item is a round navigational radar or television antenna dome, hereinafter a radome. Radomes are typically mounted on the central top of boats and have a tendency to attract birds for resting, eating, etc. When birds are resting, eating, etc., they have a increasing tendency to deposit their waste in the same general area. This action causes a tremendous amount of angst amongst boat owners due to the energy involved in cleaning up the mess. A need exists for a bird abatement system for boats that would inhibit birds from resting, eating, and depositing their waste.

The related art is represented by the following patents of interest.

U.S. Patent Application Publication No. 2001/0048503 A1, published on Dec. 6, 2001 for Bruce A. Donoho, describes a bracket insulator to provide support for wires carrying electrical current to repel birds. The Donoho application does not suggest a bird abatement system according to the claimed invention.

U.S. Patent Application Publication No. 2002/0011036 A1, published on Jan. 31, 2002 for Gordon A. Sabine, describes an antiperch device for deterring birds from perching on undesired perch locations. The Sabine application does not suggest a bird abatement system according to the claimed invention.

U.S. Patent Application Publication No. 2003/0010528 A1, published on Jan. 16, 2003 for Martin S. Niles, describes a a method and apparatus for insulating high voltage electric wires from birds and other animals. The Niles application does not suggest a bird abatement system according to the claimed invention.

U.S. Patent Application Publication No. 2003/0101634 A1, published on Jun. 5, 2003 for Tarseam S. Bhullar, describes a repellant laser beam device for preventing pests from feeding on fruits in a field. The Bhullar application does not suggest a bird abatement system according to the claimed invention.

U.S. Pat. No. 3,366,854, issued on Jan. 30, 1968 for John W. Robinson, describes apparatus and methods for electrically repelling pests from areas in which they are not wanted. The Robinson patent does not suggest a bird abatement system according to the claimed invention.

U.S. Pat. No. 4,656,770, issued on Apr. 14, 1987 for David A. Nuttle, describes a combination of visual and aural devices to create panic in selected bird species. The Nuttle patent does not suggest a bird abatement system according to the claimed invention.

U.S. Pat. No. 4,862,637, issued on Sep. 5, 1989 for Lucian W. Dressel, describes a system for repelling birds from a vineyard. The Dressel patent does not suggest a bird abatement system according to the claimed invention.

U.S. Pat. No. 5,058,335, issued on Oct. 22, 1991 for Alan J. Richter, describes a device and method for protecting a structure against roosting of birds. The Richter patent does not suggest a bird abatement system according to the claimed invention.

U.S. Pat. No. 5,255,896, issued on Oct. 26, 1993 for Lucian Letarte et al., describes an electrified fence for chasing away pigeons. The Letarte et al. patent does not suggest a bird abatement system according to the claimed invention.

U.S. Pat. No. 5,341,759, issued on Aug. 30, 1994 for Roger W. Hood, describes a sea bird deterrent for boats and navigation aids. The Hood patent does not suggest a bird abatement system according to the claimed invention.

U.S. Pat. No. 5,606,830, issued on Mar. 4, 1997 for Charles E. Townsend, Jr. et al., describes a collapsible anti-bird perching device. The Townsend, Jr., et al. patent does not suggest a bird abatement system according to the claimed invention.

U.S. Pat. No. 5,850,808, issued on Dec. 22, 1998 for Brett R. Burdick, describes a system for repelling pests provided by an elongate A-shaped plastic support having three spaced apart conductors running along the length of the support, with the middle conductor elevated relative to the other conductor and connected to a different potential of a power supply than other conductors such that when a pest steps on adjacent conductors a circuit is completed to electrically shock the pest. The Burdick patent does not suggest a bird abatement system according to the claimed invention.

U.S. Pat. No. 5,966,075, issued on Oct. 12, 1999 for Carthonia Blanks, describes a motion-sensitive bird repelling device. The Blanks patent does not suggest a bird abatement system according to the claimed invention.

U.S. Pat. No. 6,006,698, issued on Dec. 28, 1999 for Gilles Negre, describes an electrical device for repelling birds. The Negre patent does not suggest a bird abatement system according to the claimed invention.

U.S. Pat. No. 6,116,192, issued on Sep. 12, 2000 for J. Dustin Hultine et al., describes a piezoelectric shocking device for training an animal to alter or avoid particular behaviors. The Hultine patent does not suggest a bird abatement system according to the claimed invention.

U.S. Pat. No. 6,250,255 B1, issued on Jun. 26, 2001 for Martin L. Lenhardt et al., describes methods and apparatus for alerting and/or repelling birds and other animals. The Lenhardt et al. patent does not suggest a bird abatement system according to the claimed invention.

U.S. Pat. No. 6,283,064 B1, issued on Sep. 4, 2001 for Erik Djukastein et al., describes an elongated deterrant strip for mounting to an inanimate object to discourage birds and other pests from resting on that object. The Djukastein et al. patent does not suggest a bird abatement system according to the claimed invention.

U.S. Pat. No. 6,557,482 B1, issued on May 6, 2003 for Arthur F. Doty, III et al., describes an assembly for repelling birds from a selected area and having a rotor rotatably mounted on the distal end of a support member, the proximate end of which is fixed within the selected area. The Doty, III patent does not suggest a bird abatement system according to the claimed invention.

U.S. Pat. No. 3,366,854, issued on Jan. 30, 1968 for John W. Robinson, describes apparatus and methods for electrically repelling pests from areas in which they are not wanted. The Robinson patent does not suggest a bird abatement system according to the claimed invention.

Japan Patent Application Publication No. 5-336868, published in Dec. 21, 1993, describes a method for repelling birds. The Japan '868 application does not suggest a bird abatement system according to the claimed invention.

Japan Patent Application Publication No. 10-4858, published in Jan. 13, 1998, describes a device for preventing birds from flying and coming. The Japan '858 application does not suggest a bird abatement system according to the claimed invention.

Japan Patent Application Publication No. 11-9171, published in Jan. 19, 1999, describes a bird repellant device. The Japan '171 application does not suggest a bird abatement system according to the claimed invention.

Japan Patent Application Publication No. 11-89506, published in Apr. 6, 1999, describes a bird repeller capable of repelling birds in fields, plowlands, and garbage deposit places. The Japan '506 application does not suggest a bird abatement system according to the claimed invention.

Japan Patent Application Publication No. 2000-50784, published in Feb. 22, 2000, describes an injurious bird repelling device. The Japan '784 application does not suggest a bird abatement system according to the claimed invention.

None of the above references, taken either singly or in combination, is seen to describe the instant invention as claimed. Thus a bird abatement system for boats solving the aforementioned problems is desired.

### SUMMARY OF THE INVENTION

The bird abatement system for boats includes a generally circular element with a top side and a bottom side. When the bird abatement system is powered by the power of a boat or electrical power from the vessel support system, on the top side of the bird abatement system a positively charged wire of a predetermined length and a negatively charged wire of a predetermined length are embedded and/or are attached so that they are closely spaced to each other for the extent of their length.

The positively and negatively charged wires may be oriented in a variety of ways. One example is in the form of a swirl, where one end of the swirl begins with ends of the positive and negative wires at the center of the generally circular element and curls about itself with the positive and negative wires closely proximate to one another without touching each other, and one end of the swirl ends with ends of the positive and negative wires extending from the edge of the circumference of the top side of the generally circular element.

A plurality of dowel pins may be mounted on the bottom side of the bird abatement system to enable the bird abatement system to be removably mounted to the top of a radome in a snug manner. Fastening straps may also be attached to either the top or bottom sides of the generally circular element to enable the bird abatement system to be secured to a radome so as to avoid dislodgment. Ends of the fastening strips include fastening means for engaging with each other.

Accordingly, it is a principal aspect of the invention to provide a bird abatement system for boats that includes a generally circular element with a top side and a bottom side, a power supply, a positively charged wire having a predetermined length, and a negatively charged wire having a predetermined length, wherein the positively charged and negatively charged wires are embedded/attached in the top side so that they are proximate one another for the extent of their length, inhibit birds from resting, eating, and depositing their waste on boats, and enhance the cleanliness of canvas and gel-coat of any boat.

It is another aspect of the invention to provide a bird abatement system for boats that includes a generally circular element with a top side and a bottom side, a power supply, a positively charged wire having a predetermined length; a negatively charged wire having a predetermined length; and a seven and a half watt light in series with the positively and negatively charged wires to ensure that birds are encouraged to move on and are not hurt, wherein the positively charged and negatively charged wires are embedded/attached in the top side so that they are proximate one another for the extent of their length, inhibit birds from resting, eating, and depositing their waste on boats, and enhance the cleanliness of canvas and gel-coat of any boat, further comprising.

Still another aspect of the invention is to provide a bird abatement system for boats that includes a generally circular element with a top side and a bottom side, a power supply, a positively charged wire having a predetermined length; and a negatively charged wire having a predetermined length, wherein the positively charged and negatively charged wires are embedded/attached in the top side so that they are proximate one another for the extent of their length, are configured in the form of a swirl, one end of the swirl beginning with ends of the positive and negative wires at the center of the generally circular element and curling about itself with the positive and negative wires closely proximate to one another without touching each other, and one end of the swirl ending with ends of the positive and negative wires extending from the edge of the circumference of the generally circular element, inhibit birds from resting, eating, and depositing their waste on boats, and enhance the cleanliness of canvas and gel-coat of any boat.

It is an aspect of the invention to provide improved elements and arrangements thereof in a bird abatement system for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an environmental, perspective view of a boat on which is mounted a bird abatement system according to the present invention.

FIG. 2 is top perspective view of a bird abatement system according to the invention.

FIG. 3 is a top view of a bird abatement system according to the invention.

FIG. 4 is a bottom view of a bird abatement system according to the invention.

Similar reference characters denote corresponding features consistently throughout the attached drawings.

### DETAILED DESCRIPTION OF THE PREFERRED EMBODIMENTS

The present invention is a bird abatement system for boats. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

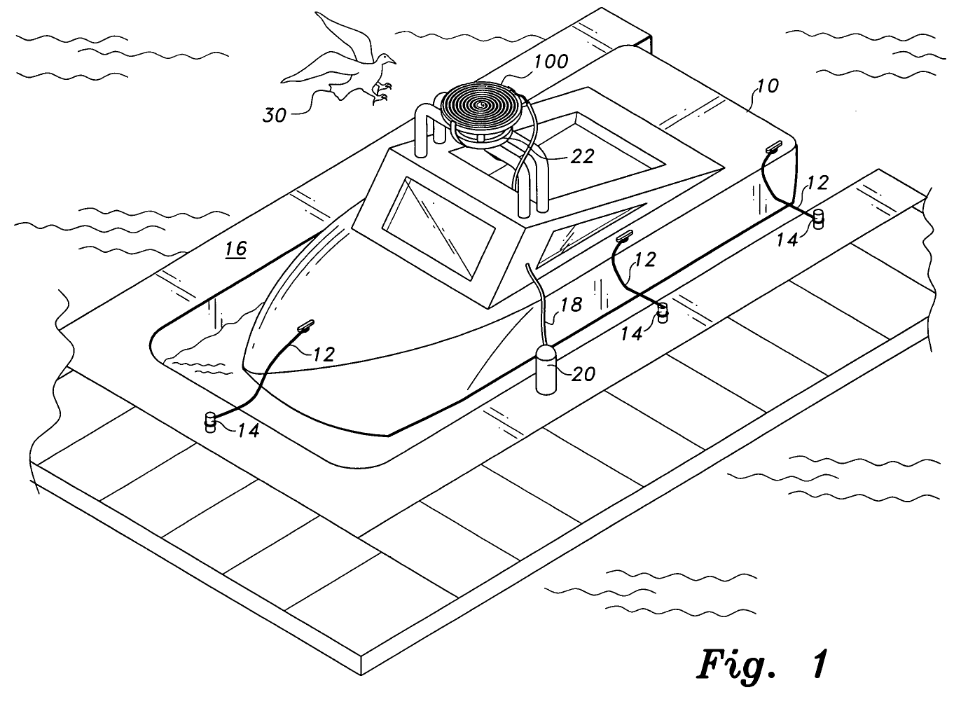

Referring to the drawings, FIG. 1 illustrates a boat 10 moored via lines 12 and davits 14 to a dock 16. The cables 18 pertain to the provision of cable TV, electrical power, and the hoses or lines for water or phone and are all attached to a deckside vessel support system 20 to continue the delivery of these utilities to the boat 10. The boat 10 includes a radome 22 (a navigational radar or television antenna dome) mounted at the top of a central portion of the boat 10. The bird abatement system 100 according to the invention is mounted on top of the radome 22.

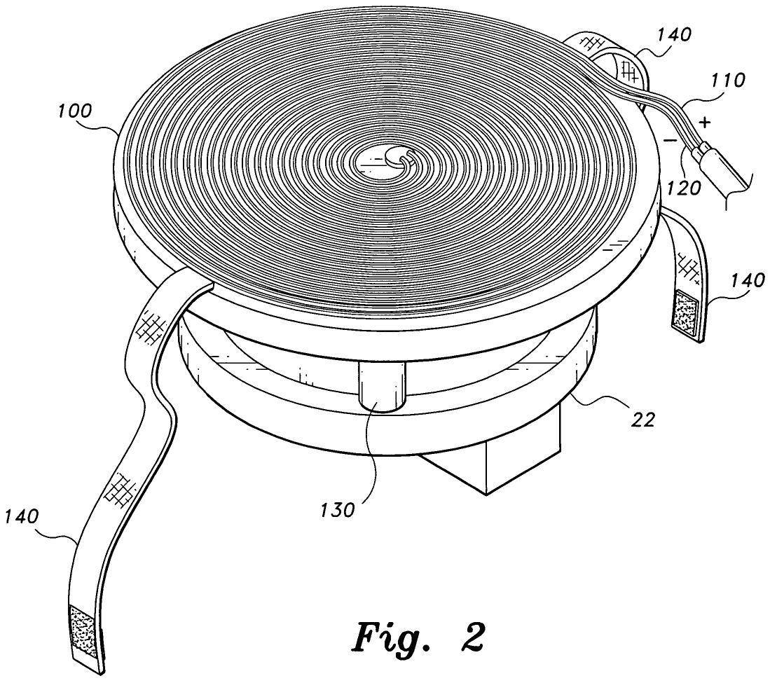

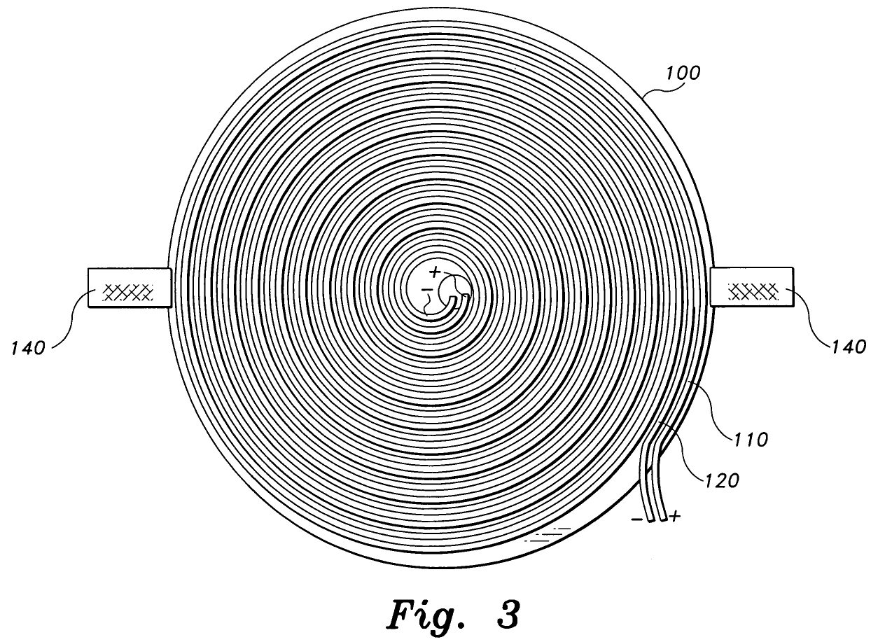

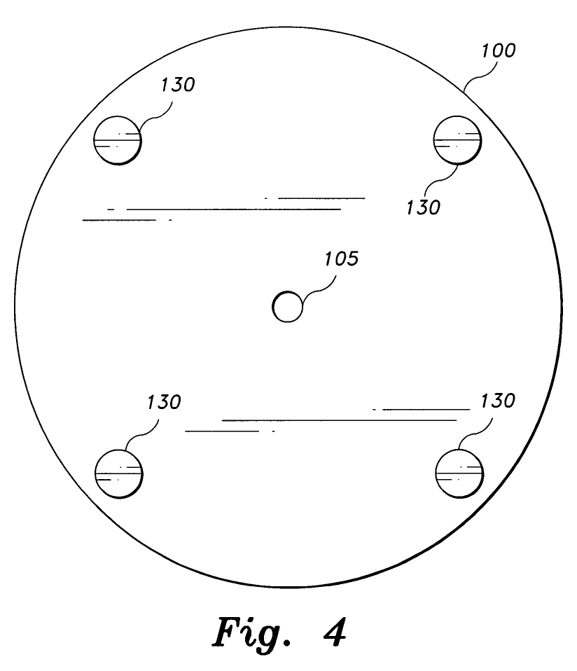

The bird abatement system 100 includes a generally circular element with a top side and a bottom side. The generally circular element is preferably made of durable material, such as a peg board with a masonite cover (see FIGS. 2-4). When the bird abatement system 100 is powered by the power of the boat 10 or electrical power (120 VAC) from the vessel support system 20, on the top side of the generally circular element a positively charged wire 110 of a predetermined length and a negatively charged wire 120 of a predetermined length are embedded and/or are attached so that they are closely spaced to each other for the extent of their length.

The positively and negatively charged wires 110, 120 may be oriented in a variety of ways. The positively and negatively charged wires 110, 120 are preferably fourteen, sixteen, or eighteen gauge bare copper wire. The positively and negatively charged wires 110, 120 are also preferably in series with a seven and a half watt light to ensure that birds are encouraged to move on and are not hurt.

One example is in the form of a swirl as shown in the drawings. One end of the swirl begins with ends of the positive and negative wires 110, 120 at the center 105 of the generally circular element and curls about itself with the positive and negative wires closely proximate to one another without touching each other, and one end of the swirl ends with ends of the positive and negative wires 110, 120 extending from the edge of the circumference of the generally circular element of the bird abatement system 100.

A plurality of dowel pins 130 (four are shown) may be mounted on the bottom side of the generally circular element to enable the bird abatement system 100 to be removably mounted to the top of a radome 22 in a snug manner. The positioning of the dowel pins 130 may be varied and/or adjusted to accommodate radomes having wide circumference range. Fastening straps may also be attached to either the top or bottom sides of the bird abatement system 100 to enable the bird abatement system to be secured to a radome 22 so as to avoid dislodgment due to high winds or the like. Ends of the fastening strips 130 include fastening means for engaging with each other, which may be hook and loop elements, adhesive tape, buckles, etc.

The bird abatement system 100 inhibits birds from resting, eating, and depositing their waste on boats, and enhances the cleanliness of canvas and gel-coat of any boat.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. A bird abatement system for boats, said system comprising:
a generally circular element with a top side and a bottom side;
a plurality of dowel pins mounted on the bottom side of the generally circular element to enable the bird abatement system to be removably mounted to the top of a radome in a snug manner;
a power supply,
a positively charged wire having a predetermined length; and
a negatively charged wire having a predetermined length,
wherein the positively charged and negatively charged wires are embedded/attached in the top side so that they are proximate one another for the extent of their length, inhibit birds from resting, eating, and depositing their waste on boats, and enhance the cleanliness of canvas and gel-coat of any boat.

2. The bird abatement system according to claim 1, wherein the generally circular element is a peg board with a masonite cover.

3. The bird abatement system according to claim 1, wherein the positively and negatively charged wires are fourteen, sixteen, or eighteen gauge bare copper wire.

4. The bird abatement system according to claim 1, further comprising a seven and a half watt light in series with the positively and negatively charged wires to ensure that birds are encouraged to move on and are not hurt.

5. The bird abatement system according to claim 1, wherein the positively and negatively charged wires are configured in the form of a swirl, one end of the swirl beginning with ends of the positive and negative wires at the center of the generally circular element and curling about itself with the positive and negative wires closely proximate to one another without touching each other, and one end of the swirl ending with ends of the positive and negative wires extending from the edge of the circumference of the generally circular element.

6. (canceled)

7. (canceled)

8. The bird abatement system according to claim 1, further comprising fastening straps attached to the top or bottom sides of the generally circular element to enable the bird abatement system to be secured to a radome.

9. The bird abatement system according to claim 8, wherein ends of the fastening strips include fastening means for engaging with each other.

10. The bird abatement system according to claim 9, wherein the fastening means comprise hook and loop elements.

11. The bird abatement system according to claim 9, wherein the fastening means comprise adhesive tape.

12. The bird abatement system according to claim 9, wherein the fastening means comprise buckles.

13. A bird abatement system for boats, said system comprising:
a generally circular element with a top side and a bottom side;
fastening straps attached to the top or bottom sides of the generally circular element to enable the bird abatement system to be secured to a radome;
a power supply,
a positively charged wire having a predetermined length; and
a negatively charged wire having a predetermined length,
wherein the positively charged and negatively charged wires are embedded/attached in the top side so that they are proximate one another for the extent of their length, inhibit birds from resting, eating, and depositing their waste on boats, and enhance the cleanliness of canvas and gel-coat of any boat.

14. The bird abatement system according to claim 13, wherein the generally circular element is a peg board with a masonite cover.

15. The bird abatement system according to claim 13, wherein the positively and negatively charged wires are fourteen, sixteen, or eighteen gauge bare copper wire.

16. The bird abatement system according to claim 13, further comprising a seven and a half watt light in series with the positively and negatively charged wires to ensure that birds are encouraged to move on and are not hurt.

17. The bird abatement system according to claim 13, wherein the positively and negatively charged wires are configured in the form of a swirl, one end of the swirl beginning with ends of the positive and negative wires at the center of the generally circular element and curling about itself with the positive and negative wires closely proximate to one another without touching each other, and one end of the swirl ending with ends of the positive and negative wires extending from the edge of the circumference of the generally circular element.

18. The bird abatement system according to claim 13, further comprising a plurality of dowel pins mounted on the bottom side of the generally circular element to enable the bird abatement system to be removably mounted to the top of a radome in a snug manner.

19. The bird abatement system according to claim 13, wherein ends of the fastening strips include fastening means for engaging with each other.

20. The bird abatement system according to claim 19, wherein the fastening means comprise hook and loop elements.

21. The bird abatement system according to claim 19, wherein the fastening means comprise adhesive tape.

22. The bird abatement system according to claim 19, wherein the fastening means comprise buckles.
